(19) United States
(12) Patent Application Publication
(10) Pub. No.: US 2005/0062305 A1
(43) Pub. Date: Mar. 24, 2005

(54) Method and apparatus for providing a service to a slide out room

(75) Inventor: Todd Blaudow, Jacksonville Beach, FL (US)

Correspondence Address: HUSCH & EPPENBERGER, LLC, 190 CARONDELET PLAZA, SUITE 600, ST. LOUIS, MO, 63105-3441, US

(73) Assignee: TDI Products, Inc., Atlantic Beach, FL (US)

(21) Appl. No.: 10/868,595

(22) Filed: Jun. 15, 2004

Related U.S. Application Data
(60) Provisional application No. 60/505,646, filed on Sep. 24, 2003.

(51) Int. Cl. B60P 3/34

(52) U.S. Cl. 296/26.01

(57) ABSTRACT

Method and apparatus for providing a service to a slide out room are disclosed. The apparatus includes an outer slide, a connector, and a service carrier. The service carrier carries a service. The connector receives at least a portion of the service carrier and slidably engages the outer slide. The movement of the connector corresponds with the movement of the slide out room. The method includes the steps of: attaching the expandable service connector to the recreational vehicle; connecting one end of the expandable service connector to the recreational vehicle; and connecting a second end of the expandable service connector to the slide out room. A further optional step may include attaching a cover over the connector.

### CROSS-REFERENCE TO RELATED APPLICATIONS

This application claims priority from U.S. Provisional Patent Application No. 60/505,646 filed Sep. 24, 2003.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to a retractable, or slide out, room that provides auxiliary living area for mobile living quarters such as recreational vehicles and manufactured housing and, more particularly, a method and apparatus for providing a service, such as electricity, to a slide out room.

2. Related Art

The width of recreational vehicles and manufactured housing is limited to that which may be accommodated for travel on public highways. Accordingly, it has become common to provide recreational vehicles and manufactured housing with retractable rooms which provide an auxiliary living area when the mobile living quarters is parked for use, but which may be retracted into the main living area when the mobile living quarters is moved.

Recently, recreational vehicle manufacturers have provided slide out rooms with built-in outlets for electricity, telephones, and other devices. As an example, recreational vehicles are now being equipped with slide out kitchens or slide out bathrooms having electrical outlets. While these improvements provide a more “home-like” atmosphere, there has been great difficulty in presenting a cost-effective and reliable device for providing a service, such as electricity, to the slide out rooms.

U.S. Pat. No. 5,237,782 to Cooper provides an example of current technique in electrically connecting the slide out room to the recreational vehicle. Cooper teaches a slide out room frame made of rails wherein an electric cable is run through the rails. For relative movement outside of the rail, the electric cable is encased within a carrier chain. A carrier chain is a chain, usually made of plastic, with a hollow center for receiving an electric cable.

The technique taught by Cooper has many drawbacks. First, the carrier chain itself adds considerably to the cost of manufacture. Second, it is very time consuming to string the electric cable through the rails and through the carrier chain. Third, the technique must be individually adapted to each recreational vehicle application. In other words, the present technique does not allow for any economy of scale.

### SUMMARY OF THE INVENTION

It is in view of the above problems that the present invention was developed. The invention is an expandable service connector for providing a service to a slide out room. The expandable service connector includes an outer slide, a connector, and a service carrier. The service carrier contains a service. The connector receives at least a portion of the service carrier and slidably engages with the outer slide. The movement of the connector corresponds with the movement of the slide out room.

A method of manufacturing a recreational vehicle having a slide out room is also disclosed. The method includes the steps of: attaching the expandable service connector to the recreational vehicle; connecting one end of the expandable service connector to the recreational vehicle; and connecting a second end of the expandable service connector to the slide out room. In an optional step, the expandable service connector is mounted to the recreational vehicle by mounting the outer slide to the recreational vehicle frame. A further optional step may include attaching a cover over the expandable service connector.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a rear view of a recreational vehicle having a slide out room and an expandable service connector of the present invention;

FIG. 2A is an exploded view illustrating a first embodiment of the expandable service connector;

FIG. 2B is an exploded view illustrating a first position of the first embodiment;

FIG. 2C is an exploded view illustrating a second position of the first embodiment;

FIG. 2D is a perspective view of the first embodiment of the expandable service connector;

FIG. 3A is an exploded view illustrating a second embodiment of the expandable service connector;

FIG. 3B is an exploded view illustrating a first position of the second embodiment;

FIG. 3C is a perspective view of the second embodiment of the expandable service connector;

FIG. 4A is an exploded view illustrating a third embodiment of the expandable service connector;

FIG. 4B is an exploded view illustrating a first position of the third embodiment;

FIG. 4C is an exploded view illustrating a second position of the third embodiment; and

FIG. 4D is an exploded view illustrating a third position of the third embodiment.

### DETAILED DESCRIPTION OF THE PREFERRED EMBODIMENTS

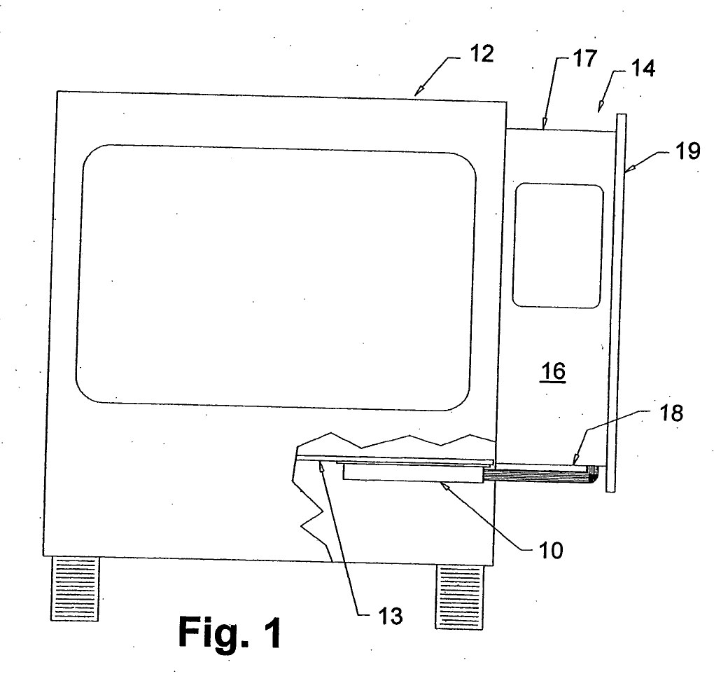

Referring to the accompanying drawings in which like reference numbers indicate like elements, FIG. 1 illustrates a rear view of a recreational vehicle 12. The recreational vehicle 12 has a slide out room 14. The slide out room has sides 16, a top 17, a bottom 18, and an exterior wall 19. An expandable service connector 10 operatively connects the slide out room 14 to the recreational vehicle 12. While in the depicted embodiment the expandable service connector 10 is connected to the bottom 18 of the slide out room 14, the expandable service connector could also be connected to one of the sides 16, the top 17, or the wall 19. Additionally, only one expandable service connector 10 is shown in FIG. 1, but those skilled in the art will understand that there may be several expandable service connectors operatively connecting the slide out room 14 to the recreational vehicle 12. Moreover, while the expandable service connector 10 is shown on the outside of the recreational vehicle 12, the expandable service connector 10 could also be located on the inside of the recreational vehicle. For example, the expandable service connector 10 could be located within a wall or ceiling of the slide out room 14. The recreational vehicle 12 includes a frame 13. In the depicted embodiment, the expandable service connector 10 is operatively connected to the frame 13. For example, the expandable service connector 10 may be welded or fastened to the frame 13. Screws, bolts, or rivets may be used to fasten the expandable service connector to the frame 13. Those skilled in the art will understand that the expandable service connector 10 could also be mounted to other portions of the recreational vehicle 12. For example, the expandable service connector 10 may be mounted on the floor, walls, or body of the recreational vehicle 12.

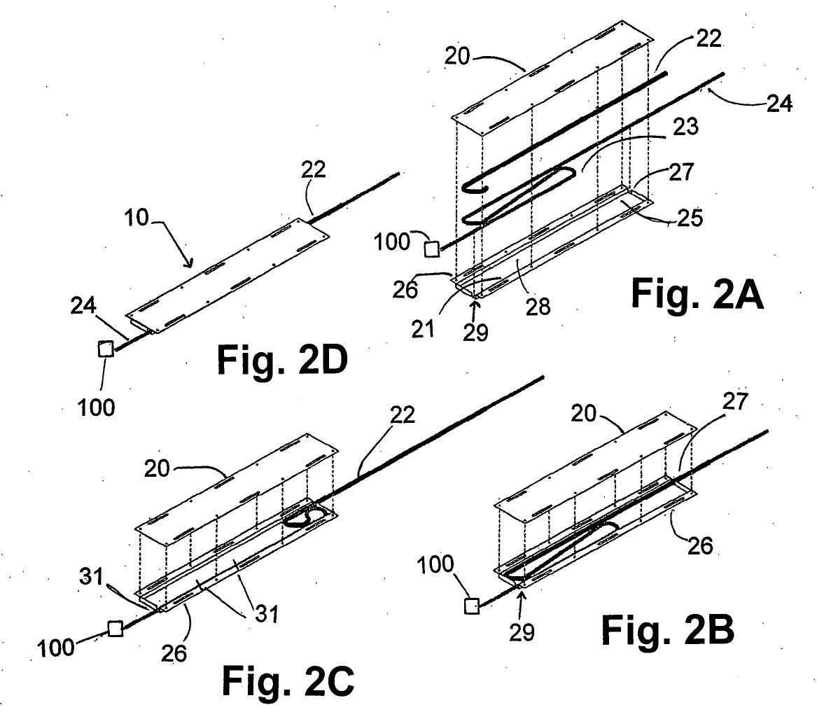

FIGS. 2A-2D illustrate a first embodiment of the expandable service connector 10. The expandable service connector 10 includes a cover plate 20, an outer slide 26, a connector 22, and a service carrier 24 for carrying a service. A service is defined to include electric service, mass communication services, telecommunications services, data services, sewer services, potable and non-potable water services, and gas services. Electric service includes both alternating current (AC) or direct current (DC). For example, electric service may be 120 Volts AC, 12 Volts DC, 24 Volts DC, or some combination thereof. The service carrier 24 is a device capable of providing a particular service. For example, if the particular service is electric service, then the service carrier 24 is an electrical wire. On the other hand, if the particular service is a mass communication service, such as cable television or satellite feed, then the service carrier 24 is a coaxial cable. The service carrier 24 can include such things as an electrical wire, a coaxial cable, a fiber optic cable, or a hose, such as a rubber or steel braided hose. The service carrier 24 may be jacketed or sleeved for the purpose of increasing the service carrier's diameter and/or reducing the service carrier's coefficient of friction. Additionally, service carrier 24 may be jacketed or sleeved for the purpose of banding services together. For example, in the context of electric service, multiple wires may be jacketed such that they are banded together. In the depicted embodiment of FIGS. 2A and 2B, the service is electrical service and hence the service carrier 24 is an electrical wire. The service carrier 24 may be round or flat. In some embodiments, a socket 100 is attached to the end of the service carrier 24 for easy installation. For example, in the case of an electrical wire service carrier, the socket 100 may be a common household plug or receptacle.

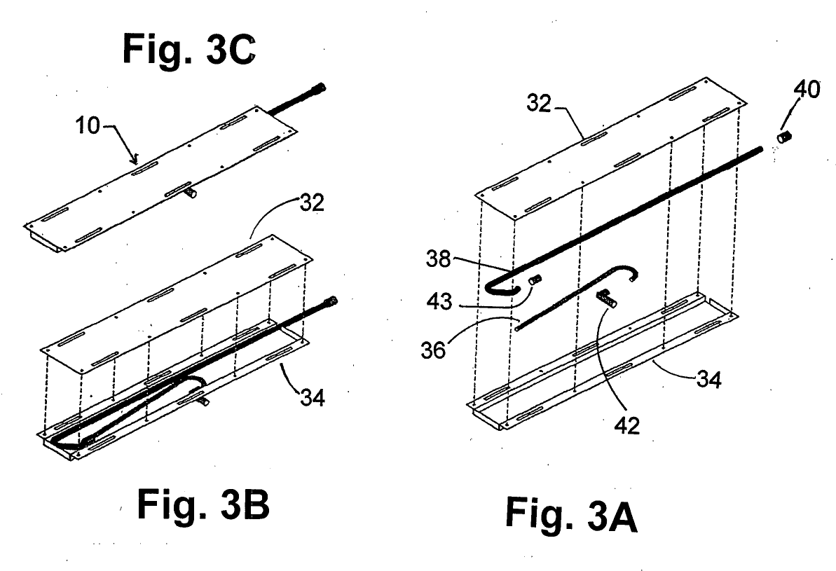

At least a portion of the service carrier 24 is located within the connector 22. The connector 22 and the service carrier 24 are “sandwiched” between the cover 20 and an inner wall 28 of the outer slide 26. The space between the inner wall 28 and the cover 20 conveniently provides a “track” in which the connector 22 and a portion of the service carrier 24 move. The connector 22 moves back and forth in the track as the slide out room 14 moves in and out of the recreational vehicle 12. In the depicted embodiment, the connector 22 is “J” shaped and a portion of the connector 22 runs parallel to a first edge 25 of the outer slide 26. The J-shape assists in preventing the rotation of the connector 22 and provides a certain amount of stability to the connector 22. Those skilled in the art will understand that other shapes may be used so long as the connector 22 cannot rotate within the track. The outer slide 26 includes an outlet 27. A portion of the connector 22 reciprocates in the outlet 27. The service carrier 24 forms a bend 23 and a portion of the service carrier 24 runs parallel to a second edge 21. The outer slide 26 includes an inlet 29. The service carrier 24 enters the outer slide 26 at the inlet 29. While in the depicted embodiment the inlet 29 is shown on one end of the outer slide 26, other locations may be used. For example, in the embodiment shown in FIGS. 3A-3C the inlet is located in the center of the outer slide 26. In the depicted embodiment, the connector 22 is a metal tube such as standard electrical conduit; however, other materials may be used.

The amount of space between the cover and the inner wall 28 depends upon the rigidity of the service carrier 24. If the service carrier 24 is very flexible, there must be very little space such that there is friction between the service carrier 24 and the adjacent members. This friction helps control the bend 23 in the service carrier 24 and prevents the service carrier 24 from developing a kink. In contrast, if the service carrier 24 has some rigidity, more space between the inner wall 28 and the cover 20 may be provided. In an extreme example, the cover 20 may be left off entirely. If too much or too little space is allowed in relation to the rigidity of the service carrier, then the service carrier may develop more than one bend and/or the service carrier 24 will kink. The expandable service connector 10 may include strain relief 31 to help immobilize the service carrier 24 and to prevent kinks. The strain relief 31 can be attached to the inlet 29 and/or the second edge 21. The strain relief, for example, can be formed by a rubber bushing, a simple bracket or standard conduit clamps.

The connector 22 slides within the outer slide 26. In the depicted embodiment of FIG. 1, movement of the connector 22 corresponds to the movement of the sliding room 14 but those of skill in the art will understand that it can be reversed. In other words, the movement of the outer slide 26 may correspond with the movement of the sliding room 14. In the depicted embodiment, the connector 22 moves at a rate of 2:1 to the movement of the center of the major bend 23.

In some embodiments the outer slide 26 is coated with a coating, such as Teflon®, to enable easier sliding. In other embodiments, a bearing or bushing (not shown) may be affixed to the outlet 27 to enable easier sliding of the connector 22. While a full cover is shown in the depicted embodiment of FIGS. 2A-2D, in some embodiments only a partial cover which covers the bend 23 through out the range of motion is provided.

FIGS. 3A-3C illustrate a second embodiment of the expandable service connector 10. The expandable service connector of FIGS. 3A-3C is used for fluid services, such as water or gas. These types of services require a different coupling than that of the first embodiment. The expandable service connector 10 includes a cover 32, an outer slide 34, a service carrier 36, a connector 38, and fluid couplings 40, 42. One side of the first fluid coupling 40 is operatively connected to the connector 38 and the other side is connected to a discharge line side (not shown). One side of the second fluid coupling 42 is operatively connected to the service carrier 36 and the other side is operatively connected to a supply line (not shown). For example, a fluid flows through the supply line, which is connected to the recreational vehicle 12, to the service carrier 36 then through the service carrier 36 and the connector 38, and finally out the discharge line to the sliding room 14. The second fluid coupling 42 is operatively mounted to the outer slide 34. A third fluid coupling 43 operatively connects the service carrier 36 and the connector 38. The connector 38 reciprocates within the outer slide 34. The movement of the connector 38 corresponds to the movement of the slide out room 14.

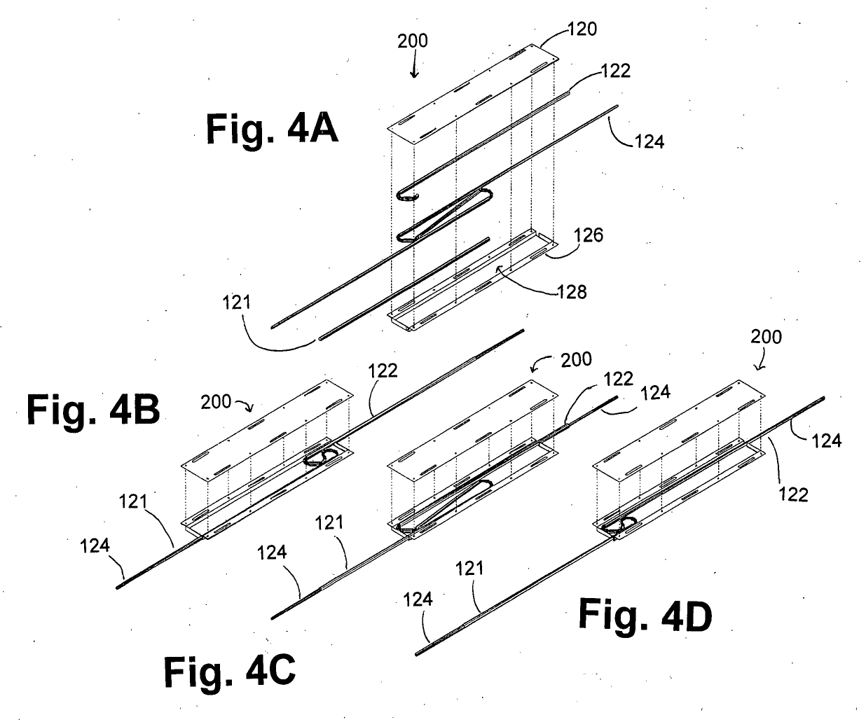

FIGS. 4A-4D illustrate a third embodiment of the expandable service connector, generally indicated by numeral 200. The expandable service connector 200 includes a cover 120, a first connector 121, a second connector 122, a service carrier 124, and an outer slide 126. As an example, the first connector 121 may be made from thin-wall tubing. In the depicted embodiments, the first connector 121 is substantially straight and the second connector 122 is “J-shaped.” However, those skilled in the art will understand that their shapes may be reversed such that the first connector 121 is “J-shaped” and the second connector 122 is substantially straight. Moreover, those skilled in the art will understand that shapes other than J-shaped may be used.

The first connector 121 and the second connector 122 each contain a portion of the service carrier 124. The first and second connectors 121, 122 and the service carrier 124 are “sandwiched” between the cover 120 and an inner wall 128 of the outer slide 126. The space between the inner wall 128 and the cover 120 provides a “track” in which the first and second connectors 121, 122 and a portion of the service carrier 124 move.

In the depicted embodiments, either or both of the first and second connectors 121, 122 move back and forth in the track as the slide out room 14 moves in and out of the recreational vehicle 12. For example, as illustrated in the embodiment depicted in FIG. 4B, the second connector 122 moves within the track to an extended position. In another example illustrated in the embodiment depicted in FIG. 4D, the first connector 121 moves within the track to an extended position. In yet another example shown in FIG. 4C, both the first and the second connectors 121, 122 can move within the track. The flexibility provided by enabling both the first and second connectors to move greatly increases the usefulness and modularity of the expandable service connector 200. In other words, the expandable service connector 200 is easily adapted to many applications and, thereby, allows for economies of scale.

A method of manufacturing a recreational vehicle having a slide out room is also disclosed. The method includes the steps of: attaching the expandable service connector to the recreational vehicle; connecting one end of the expandable service connector to the recreational vehicle; and connecting a second end of the expandable service connector to the slide out room. In an optional step, the expandable service connector is attached to the recreational vehicle by mounting the expandable service connector to the recreational vehicle frame. A further optional step may include attaching a cover over the connector.

While the embodiments shown are in relation to a recreational vehicle, those skilled in the art would understand that the present invention is applicable to other types of vehicles, such as a pop-up trailer or a mobile home, and other types of linear motion devices. In addition, while the expandable service connector is shown in relation to a horizontal sliding room, it could equally be used with a vertically sliding room. Moreover, the expandable service connector can be applied to a sliding drawer or sliding shelf.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, while the expandable service connector is illustrated as mounted to the bottom of the recreational vehicle, it could equally be mounted in another location, such as the top. Thus, the breadth and scope of the present invention should not be limited by any of the above-described exemplary embodiments, but should be defined only in accordance with the following claims appended hereto and their equivalents.

1. An expandable service connector adapted to provide a service to a slide out room, the expandable service connector comprising:
a. an outer slide having a first edge, a second edge opposite of said first edge, an inlet, an outlet, and an inner wall;
b. at least one connector in sliding contact with said inner wall, at least a portion of said at least one connector being substantially parallel to said first edge, and at least a portion of said at least one connector adapted to reciprocate within said outlet; and
c. a service carrier for carrying the service, at least a portion of said service carrier in communication with said at least one connector, at least a portion of said service carrier being substantially parallel to said second edge, and said service carrier operatively connected to said inlet.

2. The expandable service connector according to claim 1, wherein said service is selected from the group consisting of electric, mass communication, telecommunications, data, sewer, potable water, non-potable water, and gas.

3. The expandable service connector according to claim 1, wherein said service carrier is selected from the group consisting of an electrical wire, a coaxial cable, a fiber optic cable, a rubber hose, and a steel braided hose.

4. The expandable service connector according to claim 1, wherein said service carrier is jacketed.

5. The expandable service connector according to claim 1, wherein said service carrier includes a socket.

6. The expandable service connector according to claim 1, further comprising a cover.

7. The expandable service connector according to claim 1, wherein said at least one connector is J-shaped.

8. The expandable service connector according to claim 1, wherein said at least one connector is a metal tube.

9. The expandable service connector according to claim 1, wherein said service carrier includes a bend and said at least one connector moves at a ratio of 2:1 to a center of said bend.

10. The expandable service connector according to claim 1, wherein said outer slide is coated.

11. The expandable service connector according to claim 1, further comprising a strain relief operatively connected to said outlet of said outer slide.

12. The expandable service connector according to claim 1, further comprising at least one fluid coupling operatively connected to said at least one connector.

13. The expandable service connector according to claim 1, wherein said inlet is located at an end of said outer slide.

14. The expandable service connector according to claim 1, wherein said inlet is located in at a center of said outer slide.

15. The expandable service connector according to claim 1, further comprising at least one other connector.

16. In a recreational vehicle having a slide out room, the slide out room including sides, a top, a bottom, an exterior wall, the improvement comprising at least one expandable service connector operatively connected to the slide out room, said expandable service connector comprising:
a. an outer slide having a first edge, a second edge opposite of said first edge, an inlet, an outlet, and an inner wall;
b. at least one connector in sliding contact with said inner wall, at least a portion of said at least one connector being substantially parallel to said first edge, and at least a portion of said at least one connector adapted to reciprocate within said outlet, and the reciprocation of said at least one connector corresponding with a movement of the slide out room; and
c. a service carrier for carrying a service, at least a portion of said service carrier in communication with said at least one connector, at least a portion of said service carrier being substantially parallel to said second edge, and said service carrier operatively connected to said inlet.

17. The recreational vehicle according to claim 16, wherein said expandable service connector is operatively mounted on the bottom of the slide out room.

18. The recreational vehicle according to claim 16, further comprising at least one other connector.

19. The recreational vehicle according to claim 16, further comprising at least one other expandable service connector.

20. The recreational vehicle according to claim 19, further comprising at least one other connector.

21. An expandable service connector adapted to provide a service to a slide out room, the expandable service connector comprising:
a. an outer slide having a first edge, a second edge opposite of said first edge, an inlet, an outlet, and an inner wall;
b. a connector in sliding contact with said inner wall, at least a portion of said at least one connector being substantially parallel to said first edge, and at least a portion of said at least one connector adapted to reciprocate within said outlet;
c. a service carrier for carrying a service, at least a portion of said service carrier in communication with said connector, at least a portion of said service carrier being substantially parallel to said second edge, and said service carrier operatively connected to said inlet; and
d. a cover operatively connected to said outer slide.

22. A method of manufacturing a recreational vehicle having a slide out room, the method comprising the steps of:
a. attaching an expandable service connector to the recreational vehicle;
b. connecting a first end of said expandable service connector to the recreational vehicle; and
c. connecting a second end of said expandable service connector to the slide out room.

23. The method according to claim 22, wherein the step of: attaching the expandable service connector to the recreational vehicle is accomplished by mounting the expandable service connector to the recreational vehicle frame.

24. The method according to claim 22, further comprising the step of: attaching a cover to said expandable service connector.
